(19) United States
(12) Patent Application Publication
(10) Pub. No.: US 2017/0066483 A1
(43) Pub. Date: Mar. 9, 2017

(54) PROTECTIVE PLATE FOR UNDERSIDE OF VEHICLES

(71) Applicant: Roger Apostolico, Orlando, FL (US)

(72) Inventor: Roger Apostolico, Orlando, FL (US)

(21) Appl. No.: 14/846,089

(22) Filed: Sep. 4, 2015

(51) Int. Cl. B62D 25/20; B62D 65/16

(52) U.S. Cl. CPC B62D 25/2072; B62D 65/16

(57) ABSTRACT

A shield used to protect fuel harness and an electrical harness is provided. The shield is formed of a substantially flat plate having a substantially planar surface. The plate includes a first end opposite a second end, and a first side opposite a second side. The first and second sides are formed along the length of the plate. At least one flange is formed by a first bend along the first side of the plate. The first end is positioned to secure to gas tank skid plate of a vehicle. The second end is positioned to secure to a chassis of the vehicle. The at least one flange is positioned to secure to a pinch weld of the vehicle. The plate is thereby secured to the underside of the vehicle covering the fuel harness and the electrical harness.

### BACKGROUND OF THE INVENTION

The present invention relates to a protective plate and, more particularly, to a plate secured to the underside of a vehicle to prevent damage to exposed fuel and electrical harnesses.

The fuel and electrical harness on a newer model of JEEP® SUVs runs from the back of the vehicle's fuel tank to the front of the vehicle's engine compartment under the vehicle. Currently, by factory design, the harness is fully exposed on the underside of the vehicle. Therefore, the harness is exposed to destructive debris which could cause damage to the harness rendering the vehicle inoperable or potentially causing a vehicle fire.

As can be seen, there is a need for a plate that secures to the underside of the vehicle to protect the fuel and electrical harnesses.

### SUMMARY OF THE INVENTION

In one aspect of the present invention, a shield for protecting an underside of a vehicle comprises: a plate comprising a substantially planar surface, a first end, a second end, and a first side and a second side formed along a length of the plate; and a first flange formed by a first bend along the first side of the plate, wherein the first end comprises at least one bolt opening positioned to secure to a gas tank side plate of the vehicle by a first bolt, the second end comprises at least one bolt opening positioned to secure to a chassis of the vehicle by a second bolt, and the first flange comprises at least one bolt opening positioned to secure to a pinch weld of the vehicle by a third bolt.

In another aspect of the present invention, a method of protecting a fuel harness and an electric harness of a vehicle comprises: providing a shield comprising a plate having a substantially planar surface, a first end, a second end, and a first side and a second side formed along a length of the plate, wherein a flange is formed along the first side; securing the flange to a pinch weld of a vehicle; securing the first end to a gas tank skid plate of the vehicle; and securing the second end to a chassis of the vehicle.

These and other features, aspects and advantages of the present invention will become better understood with reference to the following drawings, description and claims.

### BRIEF DESCRIPTION OF THE DRAWINGS

FIG. 1 is a bottom view of an embodiment of the present invention shown in use;

FIG. 2 is a bottom perspective view of an embodiment of the present invention;

FIG. 3 is a top perspective view of an embodiment of the present invention;

FIG. 4 is a section view of the present invention taken from 4-4 in FIG. 1;

FIG. 5 is a section view of the present invention taken from 5-5 in FIG. 1;

FIG. 6 is a bottom view of the present invention unfolded; and

FIG. 7 is a side view of the present invention folded with the thickness exaggerated for clarity.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a shield or cover plate that protects the fuel line and electrical wiring harness of a JEEP® SUV vehicle used for on and off road driving. The present invention is secured to the underside of the vehicle and thereby shields the entire fuel and electrical harness from damage caused by hazardous debris. This results in keeping the vehicle's occupants safer and the vehicle operable and more dependable.

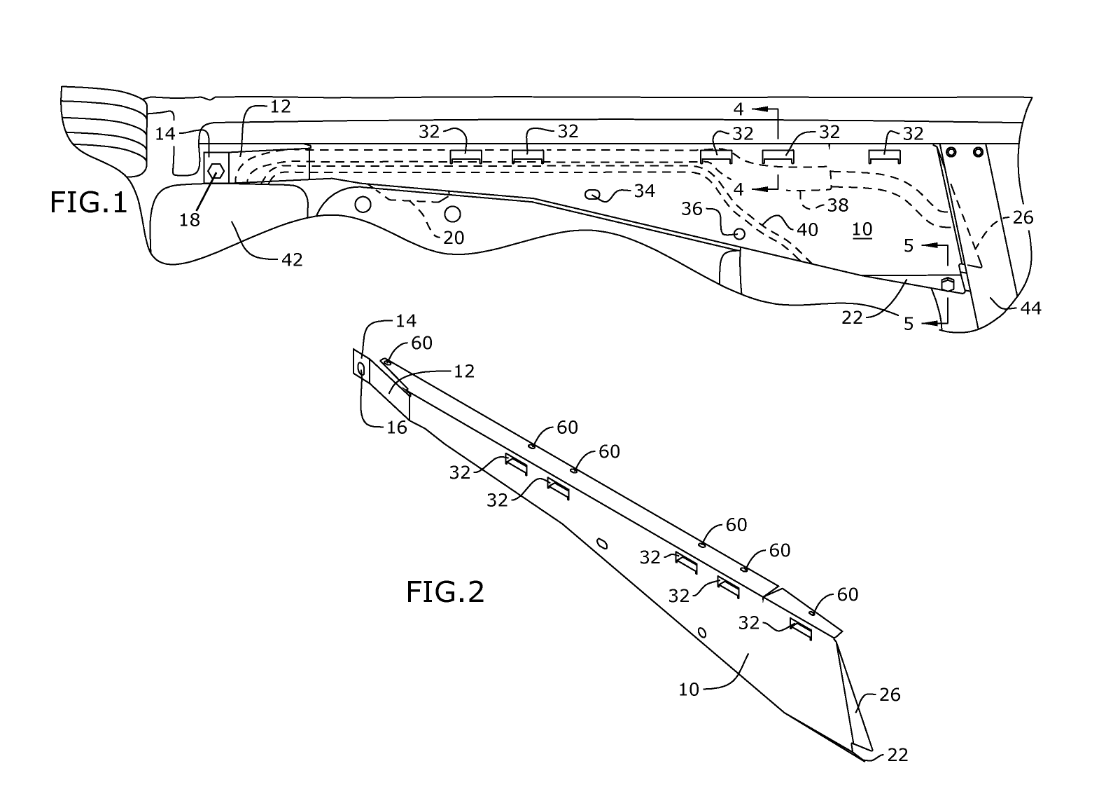

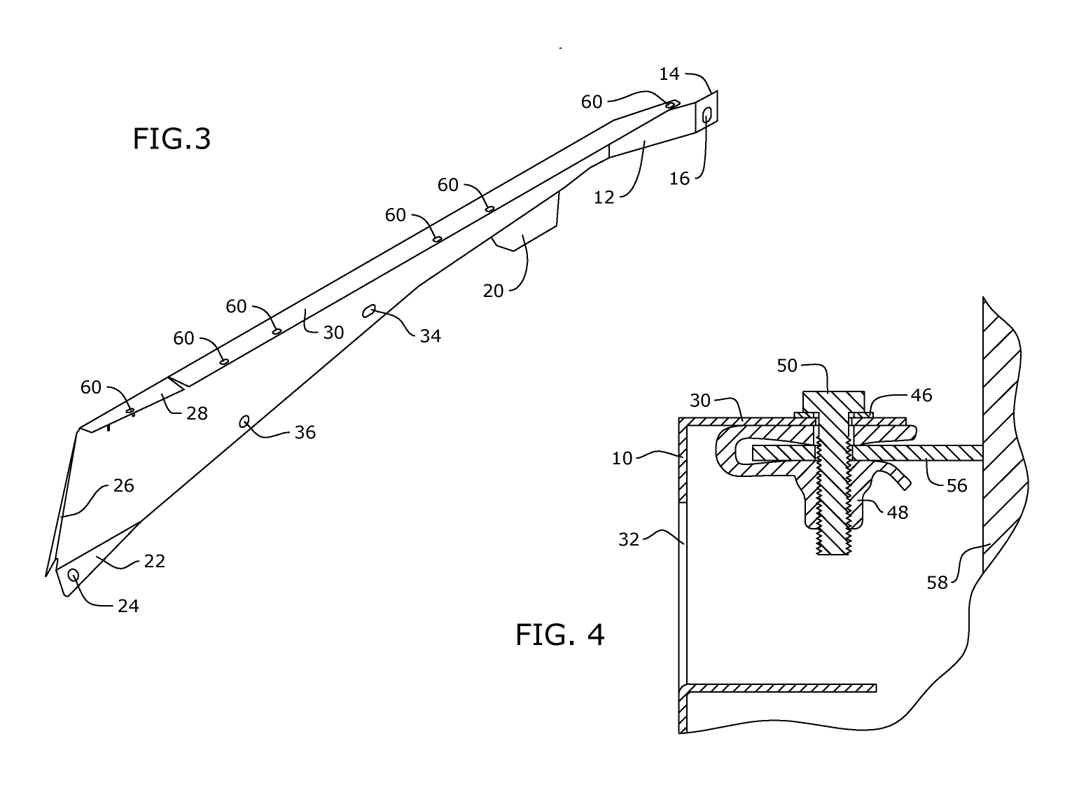

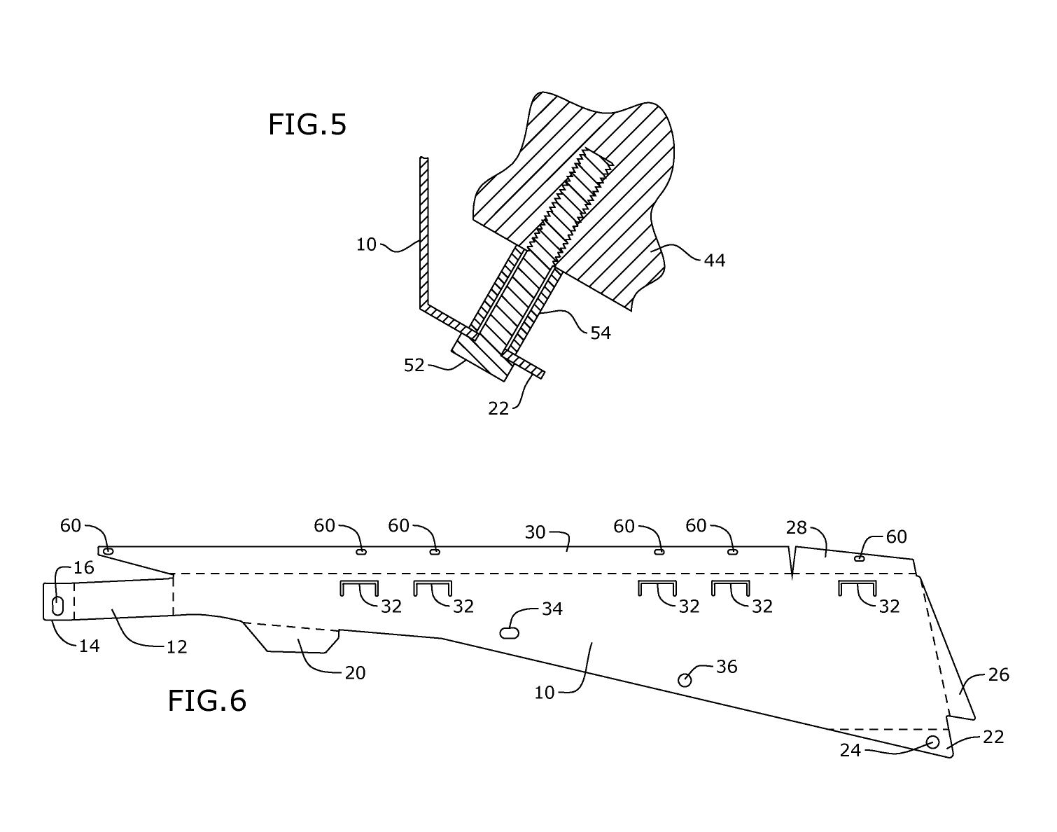

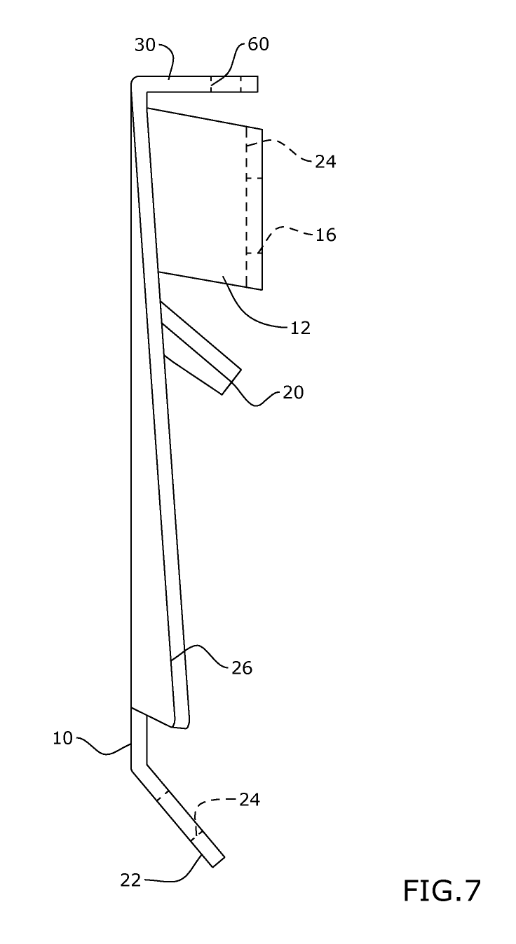

Referring to FIGS. 1 through 7, the present invention includes a shield. The shield is formed of a substantially flat plate 10 having a substantially planar surface. The plate 10 includes a first end opposite a second end, and a first side opposite a second side. The first and second sides are formed along the length of the plate 10. At least one flange 28, 30 is formed by a first bend along the first side of the plate 10. The first end is positioned to secure to a gas tank skid plate 42 of a vehicle 58. The second end is positioned to secure to a chassis 44 of the vehicle 58. The at least one flange 28, 30 is positioned to secure to a pinch weld 56 of the vehicle 58. The plate 10 is thereby secured to the underside of the vehicle 58 covering the fuel harness 38 and the electrical harness 40.

The plate 10 of the present invention may be made of a rigid material such as, but not limited to, a metal or hard polymer, such as a thick plastic. The metal may include, but is not limited to, steel, aluminum or the like. The plate 10 may include a plurality of openings therethrough. For example, the plate 10 may include access windows 32, drain slots 34 and a weep hole 36. The access windows 32 may be disposed near the first side, while the drain slots 34 and weep hole 36 may be disposed near the second side.

The at least one flange 28, 30 of the present invention may be formed along a substantial length of the plate 10. The bend forming the at least one flange 28, 30 may bend towards an upper surface of the plate 10 and may be substantially perpendicular to the upper surface. The at least one flange 28, 30 may include a long flange 30 and a short flange 28. The at least one flange 28, 30 may be broken down to the long flange 30 and short flange to align with the pinch weld 56 of the vehicle. In certain embodiments, a plurality of bolt openings 60 may be formed through the short and long flange 28, 30. The bolt openings 60 may align with openings formed in the pinch weld 56. To secure the flanges 28, 30 to the pinch weld 56, bolts 50 may run through the aligned bolt openings 60, which may be secured by U style clip nuts 48 and washers 46.

In certain embodiments, the first end may include a first fold 12 formed by a bend bending toward the upper surface of the plate 10. The first end may further include a second fold 14 formed by a bend bending away from the upper surface of the plate 10. The second fold 14 may include a bolt opening 16. The first fold 12 and the second fold 14 are formed to contour such that the first end abuts the gas tank skid plate 42 of the vehicle 58. The bolt opening 16 aligns with an opening formed in the gas tank skid plate 42. A bolt may run through the aligned openings 16, thereby secured the first end to the gas tank skid plate 42.

In certain embodiments, the second end may include at least one chassis fold 22, 26. The at least one chassis fold 22, 26 is formed by bend bending toward the upper surface of the plate 10. The at least one chassis fold 22, 26 may include a first chassis fold 26 and a second chassis fold 22. The first chassis fold 26 is positioned to be secured above the chassis 44. The second chassis fold 22 may include a bolt opening 24. In certain embodiments, the first chassis fold 26 may be formed at the first end in between the first side and second side, and the second chassis fold 22 may be formed at the first end on the second side. The bolt opening 24 aligns with an opening formed in the chassis 44. A bolt 52 may run through the aligned openings 24 with a bushing 54 secured to space the plate 10 a distance away from the chassis 44. The chassis folds 22, 26 are angled to contour with the chassis 44.

In certain embodiments, the present include may include a side fold 20. The side fold 20 may be formed by a bend bending toward the upper surface of the plate 10. The side fold 20 may be formed on the second side of the plate 10 and may be disposed beneath the chassis 44 of the vehicle 58. The side fold 20 may be used to further stabilize the plate 10 relative to the vehicle 58.

It should be understood, of course, that the foregoing relates to exemplary embodiments of the invention and that modifications may be made without departing from the spirit and scope of the invention as set forth in the following claims.

What is claimed is:

1. A shield for protecting an underside of a vehicle comprising:
a plate comprising a substantially planar surface, a first end, a second end, and a first side and a second side formed along a length of the plate; and
at least one flange formed by a first bend along the first side of the plate, wherein
the first end comprises at least one bolt opening positioned to secure to a gas tank side plate of the vehicle by a first bolt,
the second end comprises at least one bolt opening positioned to secure to a chassis of the vehicle by a second bolt, and
the first flange comprises at least one bolt opening positioned to secure to a pinch weld of the vehicle by a third bolt.

2. The shield of claim 1, wherein the first end comprises a first fold formed by a second bend bending in the same direction as the first bend.

3. The shield of claim 2, wherein a second fold is formed on the first fold by a third bend bending in the opposite direction as the first bend.

4. The shield of claim 3, wherein the second fold comprises the at least one bolt opening of the first end.

5. The shield of claim 1, wherein the second end comprises at least one chassis fold formed by a second bend bending in the same direction as the first bend.

6. The shield of claim 5, wherein the chassis fold comprises a first chassis fold and a second chassis fold, wherein the first chassis fold is positioned to be above the chassis and the second chassis fold comprises the at least one bolt opening of the second end.

7. The shield of claim 1, further comprising a plurality of access windows formed through the plate.

8. A method of protecting a fuel harness and an electric harness of a vehicle comprising:
providing a shield comprising a plate having a substantially planar surface, a first end, a second end, and a first side and a second side formed along a length of the plate, wherein a flange is formed along the first side;
securing the flange to a pinch weld of a vehicle;
securing the first end to a gas tank skid plate of the vehicle; and
securing the second end to a chassis of the vehicle.

9. The method of claim 8, wherein the first end and the second end each comprise at least one fold contouring to an underside of the vehicle.

10. The method of claim 8, wherein the plate comprises a plurality of access windows formed therethrough.
